(19) United States
(12) Patent Application Publication
(10) Pub. No.: US 2007/0208506 A1
(43) Pub. Date: Sep. 6, 2007

(54) TRAVEL SYSTEM FOR A VEHICLE

(75) Inventors: Perry Macneille, Lathrup Village, MI (US); Ronald Miller, Saline, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/276,526

(22) Filed: Mar. 3, 2006

(51) Int. Cl. G01C 21/34

(52) U.S. Cl. 701/209; 701/200

(57) ABSTRACT

The present invention discloses a travel system and method for at least one vehicle that provides travel routes. The system includes a first image capture device located on the one vehicle and configured to capture images of a road. A controller is included which is communicative with the first image capture device and configured to assemble the images to form a first map of the road. Additionally, a navigation system is included communicative with the controller for receiving the first map and providing the routes for the one vehicle.

### TECHNICAL FIELD

The present invention generally relates to a travel system and method of providing routes for a vehicle.

### BACKGROUND

Traffic congestion is identified as a major global problem for motor vehicle transportation. In some cases congestion costs billions of dollars annually in lost productivity, environmental losses due to urban sprawl, pollution, and infrastructure costs. It is commonly known that the foregoing congestion problems stem from decisions made by a motor vehicle drivers while traveling on various vehicle routes.

As such, between an origin and destination the motor vehicle driver is typically confronted by many routing choices. The driver's choices are typically made with very little knowledge of the current condition of the routes, yet these choices have a profound effect on the travel time needed. Accordingly, the aggregate of choices made by a substantial number of drivers on these same routes have a profound effect on regional congestion. Consequently, experts have developed traveler information systems that typically include a centralized traffic control center for monitoring traffic flow and reducing traffic congestion. The conventional traveler information systems may also include illuminated signs that contain traffic information, which are updated via an operator at the traffic control center. These illuminated signs provide drivers information on traffic conditions. Although the conventional traveler information systems are capable of notifying drivers of traffic conditions, there exists a wide horizon for improvement.

Particularly, conventional traveler information systems are costly to maintain in that continuous monitoring by traffic control center operators is required. Additionally, in many cases, conventional systems lack detailed route and/or traffic condition information to adequately inform the driver of his/her route options.

Accordingly, the present invention was conceived in view of these and other disadvantages of conventional traveler information systems.

### SUMMARY OF THE INVENTION

The present invention discloses a travel system for at least one vehicle that provides travel routes. The system includes a first image capture device located on the one vehicle and configured to capture images of a road. A controller is included which is communicative with the first image capture device and configured to assemble the images to form a first map of the road. Additionally, a navigation system is included communicative with the controller for receiving the first map and providing the routes for the one vehicle.

A method of providing travel routes to at least one vehicle is also disclosed. The method includes capturing images of a road through the use of a first image capture device located on the one vehicle. The method also includes assembling the images to form a first map of the road through the use of a controller communicative with the first image capture device. The method may further include receiving the first map and providing the routes for the one vehicle through the use of a navigation system communicative with the controller.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings in which:

FIG. 1 illustrates a vehicle having a navigation system in accordance with an embodiment of the present invention;

FIG. 2 is a traffic flow diagram that illustrates various traffic flow classifications in accordance with an embodiment of the present invention;

FIG. 3 illustrates a travel system that provides routes for vehicles in accordance with an embodiment of the present invention;

FIG. 4 illustrates a method for capturing a road condition and transmission of information related to the road condition to a vehicle, in accordance with an embodiment of the present invention; and

FIG. 5 illustrates an alternative embodiment of a travel system wherein multiple vehicles capture road conditions and generate regional maps based on the captured information according to an embodiment of the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular proponents. Therefore, specific functional details disclosed herein are not to be interpreted as limiting, but merely as a representative basis for the claims and/or as a representative basis for teaching one skilled in the art to variously employ in the present invention.

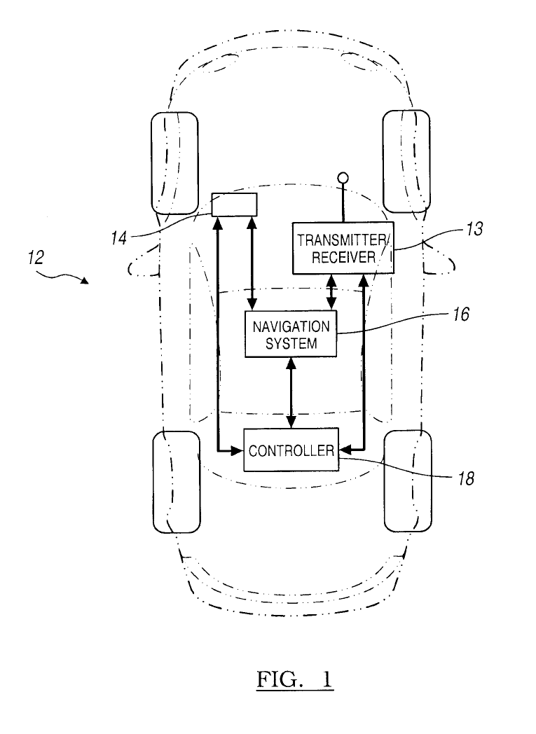

Referring to FIG. 1, a vehicle 12 is shown that is configured to capture, receive, and transmit data related to a road condition. Additionally, vehicle 12 is capable of providing optimal travel routes to a vehicle driver in an efficient manner, as will be described hereinafter. Vehicle 12 includes a transmitter/receiver 13, an image capture device 14, a navigation system 16, and a controller 18. It is recognized that although the transmitter/receiver 13, the image capture device 14, navigation system 16, and controller 18 are shown as discrete devices, they may be integrated as a single module or any number of modules without departing from the scope of the present invention.

Transmitter/receiver 13 enables the transmission and/or reception of signals from other vehicles, facilities, satellites and/or devices. Image capture device 14 may be a camera that is adapted to capture images of a road including, but not limited to, traffic congestion and the like. In alternative embodiments, image capture device 14 may utilize radar, lidar, sonar and the like for ascertaining road conditions, including traffic congestion. Upon the capture of the road condition, data pertaining to the images may be sent to navigation system 16 and/or controller 18. Controller 18, being operable with navigation system 16, is configured to assemble the images to form a map of the road. Additionally, controller 18 is capable of determining the distance between vehicle 12 and other vehicles in response to the images received from image capture device 14 through the use of photogrammetry.

In one embodiment, navigation system 16 communicates with transmitter/receiver 13, image capture device 14 and controller 18 so as to provide the driver travel routes in response to the images of the road. As such, in response to images received from image capture device 14, navigation system 16 is adapted to classify traffic flows on the road, which may be used in determining optimal travel routes for the driver. Navigation system 16 may include a display (not shown) in which to display maps and related information. Additionally, navigation system 16 may have a speaker coupled thereto for audibly outputting travel routes and other information to the driver. Navigation system 16 may also be connected to a position, speed, and/or bearing sensor such as a global positioning system (GPS) for determining the position and /or location of other vehicles, devices, and the like. In some embodiments, as recognized by one of ordinary skill, navigation system 16 may have volatile and/or non-volatile memory for storing maps of a particular region or area. Accordingly, navigation system 16 may also include a disk drive for inserting removable media containing maps and other travel related information.

Furthermore, navigation system 16 and controller 18 are capable of superimposing maps on other maps or routing data. For example, navigation system 16 may superimpose maps formed in response to images received via image capture device 14 on maps contained in either the memory or removable media of navigation system 16. In one aspect of the present invention, the map formed in response to the images received via image capture device 14 is a congestion map. The congestion map includes a graphical representation of traffic congestion areas for a particular area or region. Accordingly, navigation system 16 may have a conventional road map stored in memory or removable media. Superimposing the congestion maps onto the conventional road maps contained by navigation system 16 enables the formation of an accurate road congestion map. The road congestion map accurately informs the driver of virtually any road congestion problems for specific roads, streets, and the like. Based on the congestion map, the navigation system is enabled to provide prioritized travel routes that enable the driver to select the most efficient route to a destination.

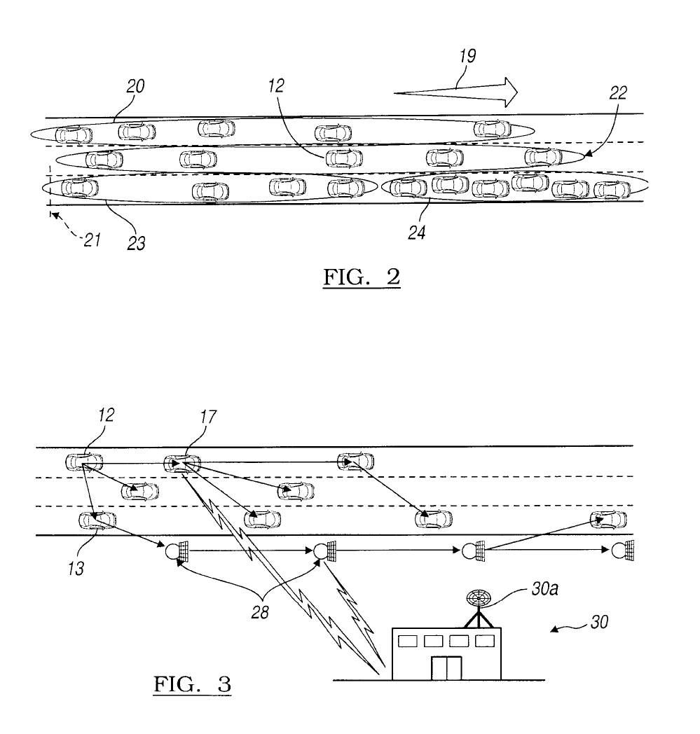

Referring to FIG. 2, various flow types are illustrated in accordance with an embodiment of the invention. As described in the foregoing, navigation system 16 is adapted to classify traffic flows. As shown, vehicle 12 along with other vehicles are traveling in the direction of traffic flow arrow 19. In one embodiment of the present invention, there exists two primary vehicle flow types. The two primary vehicle flow types include, but are not limited to a queued and a mobile flow type. In FIG. 2, flow type 24 illustrates a queued flow type, wherein the vehicle's speed may be limited by a minimal distance between vehicles. Flow type 22 illustrates a mobile flow type wherein the vehicle's speed is primarily limited by factors such as the speed limit, vehicle top speed, or the driver's comfort level with a specific driving speed.

In an embodiment of the present invention, a transition between the queued and mobile flow types is either a divergent or convergent flow type. A convergent flow type is a transition flow type between a mobile flow and a queued flow. Flow type 23 illustrates a converging flow. Flow type 23 also has a congestion front 21 that depicts a point at which traffic becomes congested. Divergent flows are transition flows from the queued to the mobile flow type. Flow type 20 illustrates a diverging flow wherein vehicles are transitioning from a queued flow type to the mobile flow type.

As described above, navigation system 16 (FIG. 1) is adapted to classify traffic flows on a road based on images received via transmitter/receiver 13. Accordingly, based on the traffic flow classification, the navigation system may compute available routes between the vehicle's location and destination. As such, the navigation system may prioritize computed routes based on an estimated travel time and the traffic flow classification.

Now, referring to FIG. 3, a travel system is illustrated that provides travel routes to the vehicle driver and occupants in accordance with an embodiment of the present invention. As described in the foregoing, vehicle 12 is configured to capture images of the road (e.g., traffic congestion) and transmit data pertaining to the images to other vehicles such as a vehicle 17. In one embodiment, vehicle 12 may be capable of transferring traffic and map related signals to vehicles within a predetermined distance, such as 100 meters. As such, the transmitter/receiver of vehicle 12 does not require a substantial amount of power to operate.

As shown in FIG. 3, several stationary traffic devices 28 and central facility 30 are included. Stationary traffic devices 28 are configured to capture images of the road including traffic flow information, classify the traffic flows, and transmit corresponding images to other vehicles and/or other stationary traffic devices. In one aspect of the present invention, stationary traffic devices 28 may be configured to operate on solar power. As such, stationary traffic devices 28 may include an energy storage device such as a battery or a capacitor that stores the solar energy.

In either embodiment, the vehicle receives the images of the road transmitted by stationary traffic device 28 via the transmitter/receiver. In response, the vehicle controller assembles the images to form a map of the road and the navigation system provides optimal routes for the driver. The stationary traffic devices 28 are also configured to receive signals from vehicles 12, 17, and the like, and generate a corresponding map of the road based on the received signals. In response, stationary traffic devices 28 may also transmit the map data to other vehicles.

Central facility 30 may be a centralized location for receiving, processing, and transmitting traffic related data and information. As such, central facility 30 may include computers configured to analyze traffic flow based off of images received from vehicles (e.g., vehicle 17) and/or stationary traffic device 28. Central facility 30 may also generate maps of various roads and regions that are transmitted to other vehicles or stationary traffic devices 28.

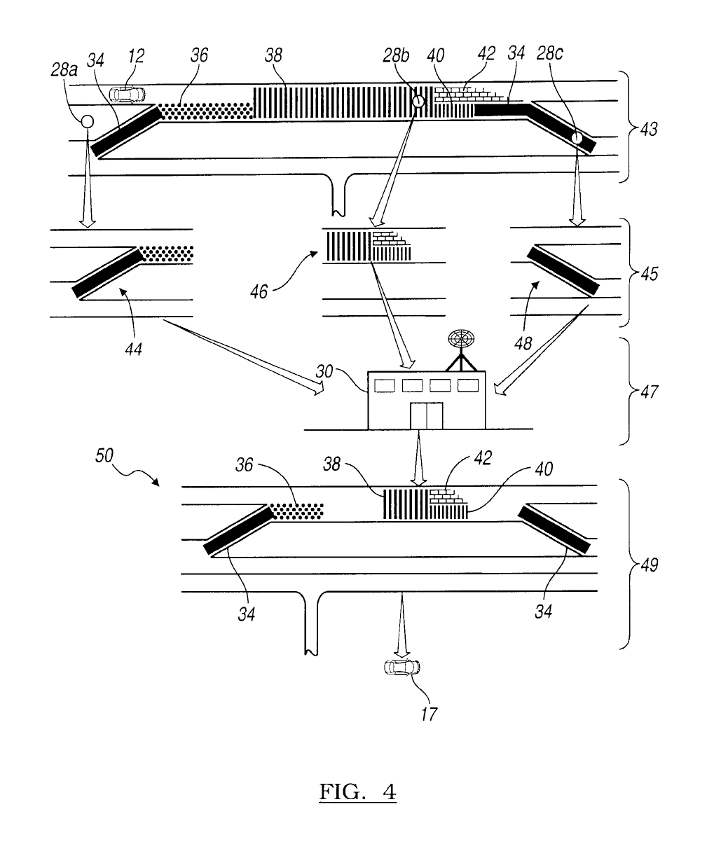

Referring to FIG. 4, a detailed illustration of a travel system for a vehicle is illustrated. Brackets 43, 45, 47, and 49 illustrate various stages in the processing of traffic related information. Within bracket 43 a roadway is illustrated having multiple traffic flows as indicated by the varying shading patterns. As shown, vehicle 12 is located on a lane of the road. Several stationary traffic devices 28a, 28b, and 28c are located at various points along the road to detect the specific traffic flows. As shown, stationary traffic device 28a is located in relative close proximity to a merging point for vehicles leaving an exit ramp and vehicles traveling on the roadway. Stationary htraffic device 28b is positioned at a straight-away point on the road. Stationary traffic device 28c is located on an exit ramp for the road.

As indicated by the various shading patterns of the road, there exists several traffic flows. Traffic flow 34 illustrates queued traffic and traffic flow 36 illustrates diverging traffic. Traffic flows 38 and 42 illustrate mobile and stranded traffic flows, respectively. It is recognized that stranded traffic flows may be the same as a queued traffic flow, but includes vehicles that are incapable of moving although they are located on the road. Bracket 43 includes several stationary traffic devices 28a, 28b, and 28c. As described above, stationary traffic devices 28a, 28b, and 28c are adapted to capture images of the road.

Bracket 45 illustrates partial images of the road condition captured by stationary traffic devices 28a, 28b, and 28c. Specifically, stationary traffic device 28a has captured image 44 that includes queued and diverging traffic flows as indicated by the corresponding shading patterns. Stationary traffic device 28b has captured image 46 that includes an image of mobile, stranded, and converging traffic flows. Stationary traffic device 28c has captured image 48 which includes queued traffic 34.

It is recognized that vehicle 12 is capable of capturing images in substantially the same manner as stationary traffic devices 28a, 28b, and 28c. Nevertheless, once images 44, 46, and 48 are captured, these images are transmitted to central facility 30 as shown in bracket 47.

Central facility 30 is capable of assembling the partial maps received from stationary traffic devices 28a, 28b, and 28c. Additionally, central facility 30 includes storage computers having map data related to the region in which stationary traffic devices 28a, 28b, and 28c are located. Based on the received images and the stored traffic related map data, a regional map 50 is composed via central facility 30. Accordingly, the regional map 50 is transmitted to vehicle 17 wherein the navigation system of vehicle 17 provides optimal routes in response to the traffic conditions of the road.

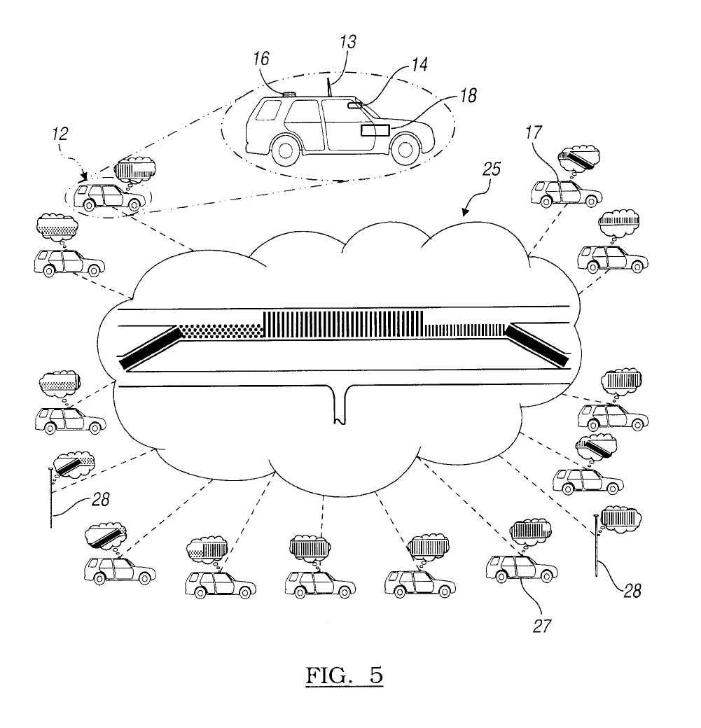

Referring to FIG. 5, an embodiment of the travel system is illustrated wherein vehicles capture road condition information and transmit the related information to other vehicles to generate a regional map. In this embodiment, which may be referred to as a distributed travel information system, each vehicle contains a middleware solution 25 for transmitting road condition data and assembling a regional map based on the captured road condition data. In some embodiments, the vehicles may have middleware solutions that include, but are not limited to JAVAT, JINI, common object request broker architecture (CORBA), and Linda in a mobile environment (LINDA). Accordingly, via image capture device 14, the middleware solution 25 and the controller 18, each vehicle (e.g., vehicles 12, 17, 27 and the like) captures and stores at least a portion of a regional map in the memory of the controller 18. Each vehicle wirelessly transmits its portion of the map to other vehicles. Based on the stored and received data, the vehicles assemble a map of that particular region. Additionally, in some embodiments, stationary traffic devices 28 may be utilized to capture and transmit road condition data.

While the best mode for carrying out the invention has been described in detail, those familiar with the art to which this invention relates will recognize various alternative designs and embodiments for practicing the invention as defined by the following claims.

What is claimed:

1. A travel system for at least one vehicle that provides travel routes comprising:
a first image capture device located on the one vehicle and configured to capture images of a road;
a controller communicative with the first image capture device and configured to assemble the images to form a first map of the road; and
a navigation system communicative with the controller for receiving the first map and providing the routes for the one vehicle.

2. The system of claim 1, further comprising a first transmitter/receiver configured to transmit signals corresponding to at least one of the images and the first map to at least a second travel system, wherein the second travel system is within a predetermined distance of the one vehicle.

3. The system of claim 2, wherein the second travel system is located on a second vehicle, the second travel system having a second image capture device for capturing images of the road a second transmitter/receiver for transmitting signals corresponding to the images.

4. The system of claim 3, further comprising a central facility that is operable with the one and the second vehicle, the central facility receiving images from the one vehicle and generating a map based on the received images.

5. The system of claim 3, further comprising a stationary traffic device configured to capture images of the road and transmit the corresponding images to the controller, wherein the controller assembles the images to form the first map of the road.

6. The system of claim 5, wherein the stationary traffic device is configured to receive signals from at least one of the first and the second transmitter/receiver and generate a map of the road based on the signals from the first and the second transmitter/receiver.

7. The system of claim 1, wherein the navigation system providing the routes further comprises:
classifying traffic flows on the road;
computing available routes between the vehicle's location and destination; and
prioritizing the routes based on an estimated travel time and the classifying of traffic flows.

8. The system of claim 1, wherein the controller and the navigation system contains a second map and the navigation system superimposes the first map on the second map to form a third map of the road.

9. A method of providing travel routes to at least one vehicle comprising:
capturing images of a road through the use of a first image capture device located on the one vehicle;
assembling the images to form a first map of the road through the use of a controller communicative with the first image capture device; and
receiving the first map and providing the routes for the one vehicle through the use of a navigation system communicative with the controller.

10. The method of claim 9, further comprising transmitting signals corresponding to at least one of the images and the first map to at least a second travel system via a first transmitter/receiver, wherein the second travel system is within a predetermined distance of the one vehicle.

11. The method of claim 10, wherein the second travel system is located on a second vehicle, the second travel system having a second image capture device for capturing images of the road a second transmitter/receiver for transmitting signals corresponding to the images.

12. The method of claim 11, further comprising receiving images from the one vehicle and generating a map based on the received images via a central facility, wherein the central facility is operable with the one and the second vehicle.

13. The method of claim 11, further comprising capturing images of the road and transmitting the corresponding images to the controller via a stationary traffic device, wherein the controller assembles the images to form the first map of the road.

14. The method of claim 13, wherein the stationary traffic device is configured to receive signals from at least one of the first and the second transmitter/receiver and generate a map of the road based on the signals from the first and the second transmitter/receiver.

15. The method of claim 9, wherein providing the routes for the one vehicle through the use of a navigation system further comprises:
classifying traffic flows on the road;
computing available routes between the vehicle's location and destination; and
prioritizing the routes based on an estimated travel time and the classifying of traffic flows.

16. The method of claim 9, further comprising:
storing a second map through the use of the controller and the navigation system; and
superimposing the first map on the second map to form a third map of the road.

17. A travel system for at least one vehicle that provides travel routes comprising:
at least one vehicle having a controller, an image capture device and a navigation system, the capturing device for capturing images of a road and the controller receiving the images to assemble the images thereby forming a first map, wherein the navigation system receives the first map and provides the travel routes to a vehicle occupant; and
at least one stationary traffic device having an energy storage device for powering the at least one stationary traffic device, the stationary traffic device being communicative with the at least one vehicle to receive data pertaining to at least one of the first map and the travel routes, the stationary traffic device being configured to classify traffic flows of the road and wirelessly transmit the data and information pertaining to the classified traffic flow to at least one of a second vehicle and a second stationary traffic device.

18. The system of claim 17, further comprising a central facility that is operable with the at least one vehicle and the second vehicle, the central facility receiving images from the one vehicle, generating a map based on the received images, and transmitting the map.

19. The system of claim 18, wherein the map includes traffic congestion information.

20. The system of claim 17, wherein the navigation system providing the routes includes at least one of displaying the routes on a display of the navigation system and audibly providing the routes via a speaker that is operable with the navigation system.
